(19) United States
(12) Patent Application Publication
(10) Pub. No.: US 2016/0041702 A1
(43) Pub. Date: Feb. 11, 2016

(54) Pull and Swipe Navigation

(71) Applicant: Nan Wang, San Diego, CA (US)

(72) Inventor: Nan Wang, San Diego, CA (US)

(21) Appl. No.: 14/794,763

(22) Filed: Jul. 8, 2015

Related U.S. Application Data
(60) Provisional application No. 62/022,162, filed on Jul. 8, 2014.

(51) Int. Cl. G06F 3/0482; G06F 3/0485; G06F 3/0488; G06F 3/0481

(52) U.S. Cl. CPC G06F 3/0482; G06F 3/04817; G06F 3/0485; G06F 3/04883

(57) ABSTRACT

The “Pull and Swipe Navigation” comprises a set of heuristic gesture-based commands overlaid on a smart user interface that optimizes for dynamic content and ease of navigation on touch screen devices.

The feature set improves upon existing touch screen user interface design, user experience design, and navigation by freeing up valuable on-screen real estate for relevant content by hiding otherwise static menu bars and icons until required; implementing a set of easy to use and simple to navigate heuristic commands that delineate between menu access and scrolling; making menu bars and icons accessible to the touch at any part of the touch screen, thus solving reach issues particularly for larger devices; and by providing theoretically unlimited real-estate for menu items through over-scrolling.

### CROSS-REFERENCE TO RELATED APPLICATIONS

Pursuant to Claims under 35 U.S.C. 119(e), this application is a U.S. non-provisional utility patent application claiming benefit of U.S. provisional patent application No. 62/022,162, “Pull and Swipe Navigation,” filed Jul. 8, 2014. All of these applications are incorporated by referenced herein in their entirety.

### STATEMENT OF FEDERALLY SPONSORED RESEARCH/DEVELOPMENT

Not Applicable

### TECHNICAL FIELD

The disclosed embodiments relate generally to electronic devices with touch screen displays, and more particularly, to electronic devices that apply heuristics to detected user gestures on a touch screen display to determine commands.

### BACKGROUND OF THE INVENTION

Seeking patent for a novel gesture-based navigation interface on all touch-screen enabled devices; including but not limited to mobile phones, tablets, computers, laptop computers, digital music players, televisions, and wearable devices.

Existing user navigation interfaces have several shortfalls, including the following existing examples, with their highlighted user friction points (in no particular order):

1. Ever-present bar menus
a. Having an ever-present bar menu, regardless of where it is located on the screen reduces usable “real estate” and associated pixels for actual content. On a typical program, this menu may reduce the usable screen by 5-15%, depending on the size of the menu bar used.
b. Reduced screen real estate further negatively impacts user enjoyment (an example would be if your television screen constantly showed the play, stop, forward, and rewind icons on the screen when you were attempting to enjoy a movie). User immersion and engagement may suffer as a result.
c. From a business perspective, applications and programs which rely on selling screen real estate for revenues/profits also suffer a financial hit with ever-present bar menu interfaces—the lost real estate on the screen could potentially translate to real dollar losses in revenues/profits for space otherwise saleable to advertisers. Banner advertisement revenues are big business for many applications, and the extra space saved could translate to additional financial gains.
d. In-app clutter potentially reduces the attractiveness of aforementioned real estate for advertisers. For example, if an advertising agency attempted to sell only 85% of a billboard to a large advertising sponsor, reserving the right to use the remaining 15% at its own discretion, this would likely impact the rate that the advertiser would be willing to pay, not to mention the likelihood of a contract consummation in the first place.
e. Furthermore, ever-present menu bars are constrained because there are physical limitations on the number of menu items that can be displayed simultaneously. The maximum space usable for menu navigation is confined to the width of the screen size and the height of the space allocated to the menu. In a typical app or program, the maximum number of menu items displayable is currently around five, because each individual item must be large enough to register and delineate the sensitivity from the touch of a human thumb or finger.
f. Ever-present menu bars anchored to the top of the screen are difficult to access with one hand, especially in the upper left and right corners of the screen, which are harder to reach areas. With large screen sizes (e.g., larger screen mobile phones, tablets, tablet PCs), this simple navigation becomes impossible without readjusting hand positioning, or in some instances may even require the use of a second hand in order to access menu features. This creates navigation inefficiencies, and takes away from the user experience.

2. Gesture-enabled (hidden) menus
a. In an attempt to mitigate some of the real-estate constraints highlighted in the ever-present menu bar, developers have introduced modifications to allow users to activate or deactivate the standard menu bar with gesture-based commands such as, but not limited to, a left or right swiping motion, a pull down gesture, or a push up gesture. The menu bar will activate (appear) or deactivate (disappear) based on the gesture used.

The problem with this interface is that it currently does not allow users to delineate the intent of the gesture. For example, if a user wanted to access the menu bar in existing Apps utilizing the gesture-enabled menu bar interface, they would use a swipe down gesture to activate the menu. However, this would also simultaneously scroll the page down because the gesture is being recognized as both a scroll command as well as a menu activation command. The same holds true about a push up gesture to deactivate the menu and confusing it with a simultaneous scroll up command. If you wanted to just scroll up or down, it would also trigger a menu activation command.

Existing gesture-enabled menu bar interfaces fail to cleanly execute a menu access command without unintentionally impacting other user navigation commands in the process—this could be problematic in many ways, as it may accidentally refresh a page, delete a page, or navigate away from a particular anchor point without the intent of the user.
b. In addition to the new friction points highlighted in 2(a) of this section that existing gesture-enabled menu bars fail to adequately address; gesture-enabled menu bars also fail to alleviate the friction points outlined in 1(e) and 1(f) of this section for the ever-present menu bar. Physical constraints on the number of menu items that can be simultaneously displayed, and ease of access issues for menu bars anchored to the top of mobile screens persist despite the modifications.

3. Hamburger menus
a. Another commonly used navigation interface is the hamburger menu.

Hamburger menus use an icon—typically represented by three horizontal lines that resemble the menu's namesake (or three dots)—to activate a hidden or expandable set of menu items. These icons are typically located in one of the four corners of a touch screen. Similar to the ever-present menu bar and the gesture-enabled menu bar, hamburger menus which are located in the upper left or right corners of a screen face ease-of-access issues as also discussed in 1(f). Some developers have tried to mitigate this by placing the hamburger menu on the bottom of the screen.
b. However, hamburger menus by design use an icon as a placeholder to access a menu located on a different page or screen. To access these additional menu items, a user would need to navigate away from the existing page or screen and onto a new page or screen. This process can be disjointed, and impacts the user experience by forcing users to toggle between multiple pages and/or screens. In its current design, a hamburger menu prevents users from accessing a list of menu items while still remaining immersed on the content on the page or screen they are actively engaged with.

4. Slide-away menus
a. Slide away menus behave similar to hamburger menus. An icon is typically used to access a hidden slide-away menu. Users swipe left, swipe right, or click on the icon to slide the current page away to access a menu page. Similar to the traditional hamburger menu, slide-away menus face the same inherent disjointed navigation issues highlighted in 3(b).

### BACKGROUND ART

FIG. 1 illustrates a mobile phone device with an ever-present menu bar 1 anchored to the bottom of the screen. In this case, the menu bar has five icons located at the bottom of the screen 2, 3, 4, 5, 6. These icons each represent menu items, and are ever-present (along with the menu bar in its entirety), meaning they stay on the screen regardless of where the users are navigating to within the app. Ever-present menu bars can also be anchored to the top of the mobile device.

FIG. 2 illustrates a mobile phone device with a gesture enabled menu bar in inactive mode, with the menu bar hidden from sight on the mobile device screen.

FIG. 3 illustrates a mobile phone device with a gesture enabled menu bar 7 in active mode, anchored to the bottom of the touch screen, with menu items 8, 9, 10, 11, 12. The difference between the gesture enabled menu bar and the ever-present menu bar in FIG. 1, is that the menu bar in FIG. 3 has been activated by a user swipe gesture 13, causing menu bar 7 to appear and temporary lock in place until the user swipes again in the counter motion of gesture 13 to deactivate it. The problem with existing variations of this interface is that the interface does not delineate between when you want to simply scroll, or when you want to access the menu bar. The gestures to swipe down and swipe up also correspond to often unintended scrolling in the direction of the swipe motion. This is problematic in that users who simply wish to access the menu bar are forced to scroll, and users simply wishing to scroll would activate (or deactivate) the menu bar.

FIG. 4 illustrates a mobile phone screen with a hamburger menu 14 in inactive state. In this illustration, the hamburger menu 14 is shown on the upper left hand corner of the device screen; but hamburger menus are also commonly positioned in the upper right, lower left, and lower right corners of devices as well. When users tap on the hamburger menu icon 14, it activates the hamburger menu in FIG. 5.

FIG. 5 illustrates a mobile phone screen with a hamburger menu 15 in the active state. When activated, the page/screen shifts right to reveal the hidden menu 16. In order to access this menu, users need to either partially or fully navigate away from the original page they were on.

FIG. 6 illustrates a mobile phone screen with a slide-away navigation interface before a user activates the slide away menu icon 17.

FIG. 7 illustrates a mobile phone screen with a slide-away navigation interface after a user has activated the slide away menu icon 18. In the slide-away navigation, the icon 18 was used to access hidden menu items. When a user taps the slide-away menu icon 18, the existing screen slides away (in this case to the right) to reveal a partial or full new screen 19 and its associated menu items.

### BRIEF SUMMARY OF THE INVENTION

This patent application is for a novel “Pull and Swipe” user interface and gesture-based navigation method for touch-screen enabled computing devices that conceal menu items (and sub-menu items) until they are required.

The User Interface Design (UI) and User Experience Design (UX) focuses on highlighting on-screen content by making navigation panels like menu bars and icons inactive and hidden until activated by the user using touch-enabled heuristic commands.

The gesture-based navigation method further improves upon existing touch screen navigation by allowing for delineation between menu access commands and normal scrolling commands.

The “Pull and Swipe Navigation” feature set improves upon existing touch screen user interface design, user experience design, and navigation by freeing up valuable on-screen real estate for relevant content by hiding otherwise static menu bars and icons; making menu bars and icons accessible to the touch at any part of the touch screen.

### BRIEF DESCRIPTION OF THE SEVERAL VIEWS OF THE DRAWINGS

For a better understanding of the invention, reference should be made to the following description and accompanying drawings. The drawings highlight the user interface design for the patent using a standard mobile phone device as the example, and the detailed description of the preferred embodiments further outline the mechanics behind the user navigation interface. All drawings are based on working, and existing prototypes.

FIG. 8 highlights a default screen that represents a standard page within the home screen, an application screen, or browser on a typical mobile phone.

FIG. 9 illustrates the “Pull” gesture heuristic corresponding to the revealing and activation of a hidden menu bar by pulling in a downward motion on the touch screen.

FIG. 10 illustrates the “Swipe” gesture heuristic that follows the “Pull” gesture heuristic in one contiguous motion, and which corresponds to the horizontal one-dimensional scrolling within the revealed menu bar to access different menu items.

FIG. 11 shows another example of the “Swipe” gesture heuristic (in a different direction) that follows the “Pull” heuristic in one contiguous motion, and which corresponds to the horizontal one-dimensional scrolling within the revealed menu bar to access different menu items.

FIG. 12 illustrates the “Release” gesture heuristic which activates the highlighted menu item. Following any combination of “Pull” or “Pull and Swipe,” a user simply releases touch contact with the surface of the device screen to activate the highlighted menu item. Notice that the menu bar disappears to the background when a “Release” gesture is executed.

FIG. 13 illustrates the “Push Up” heuristic that enables cancelling of the current action. As long as a user maintains touch contact with the device screen, any combination of “Pull” or “Pull and Swipe” only results in a preview of the highlighted menu items until touch contact with the surface of the device screen is released.

### DETAILED DESCRIPTION OF THE PREFERRED EMBODIMENTS

Referring to the drawings, wherein like numerals indicate like or corresponding parts throughout the several views, the following description of the preferred embodiments outline the “Pull and Swipe” navigation patent being sought.

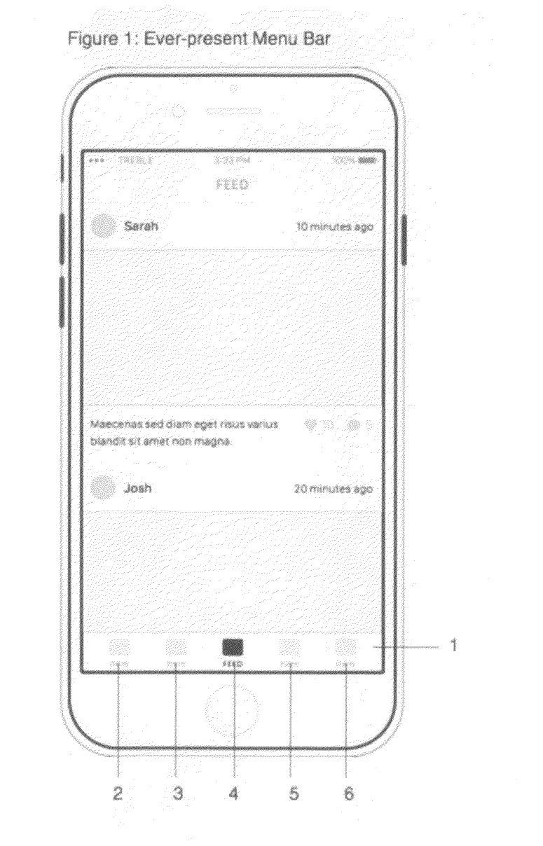

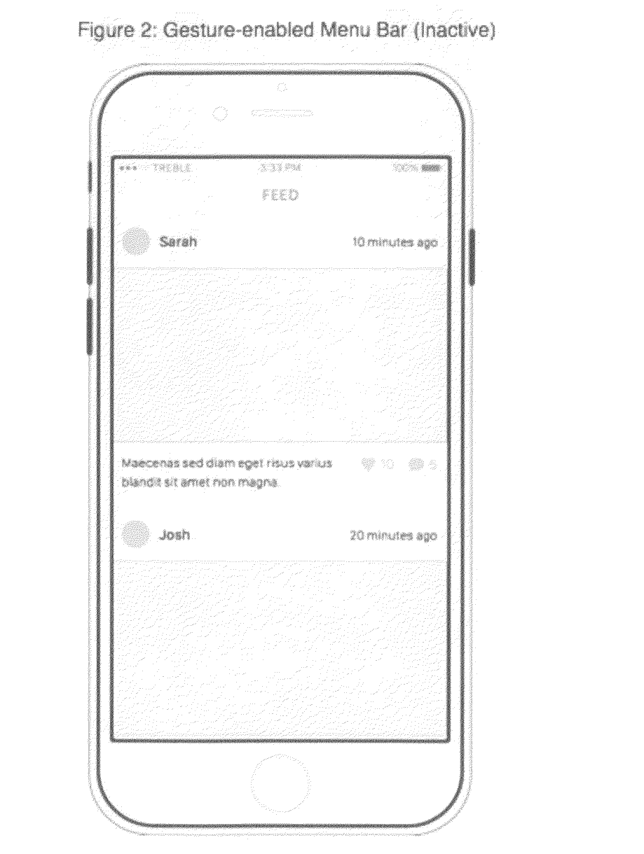

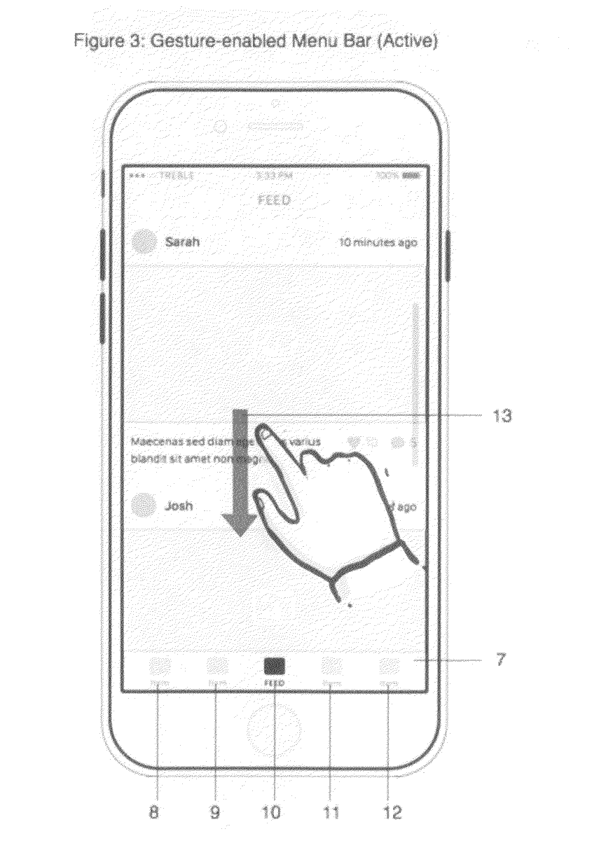

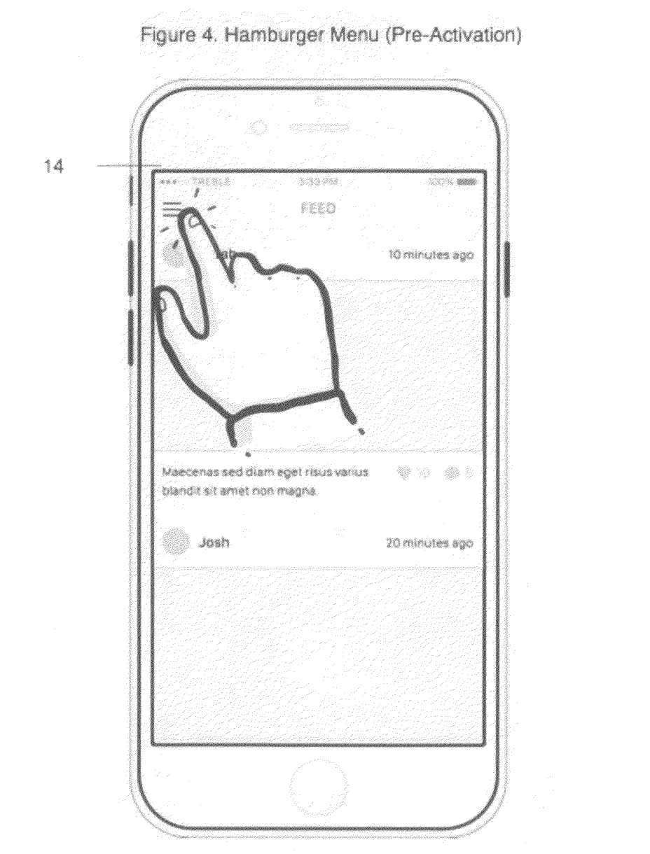

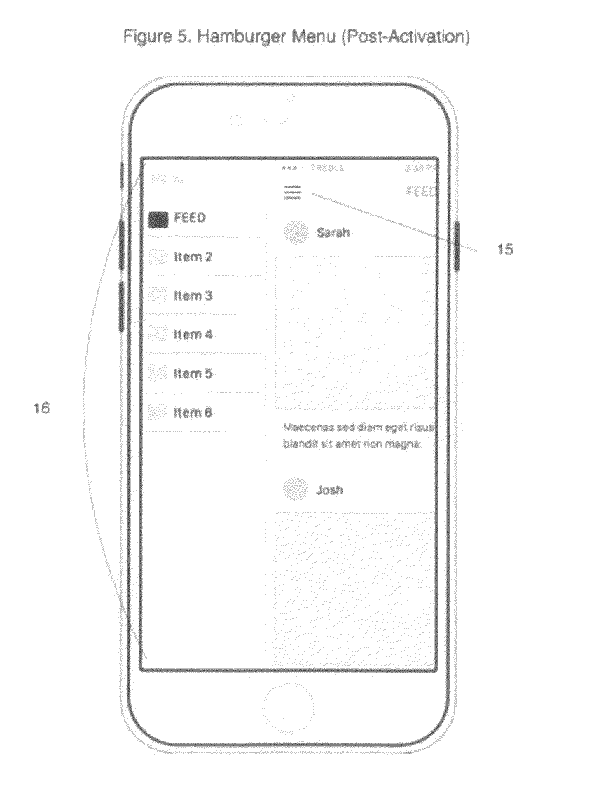

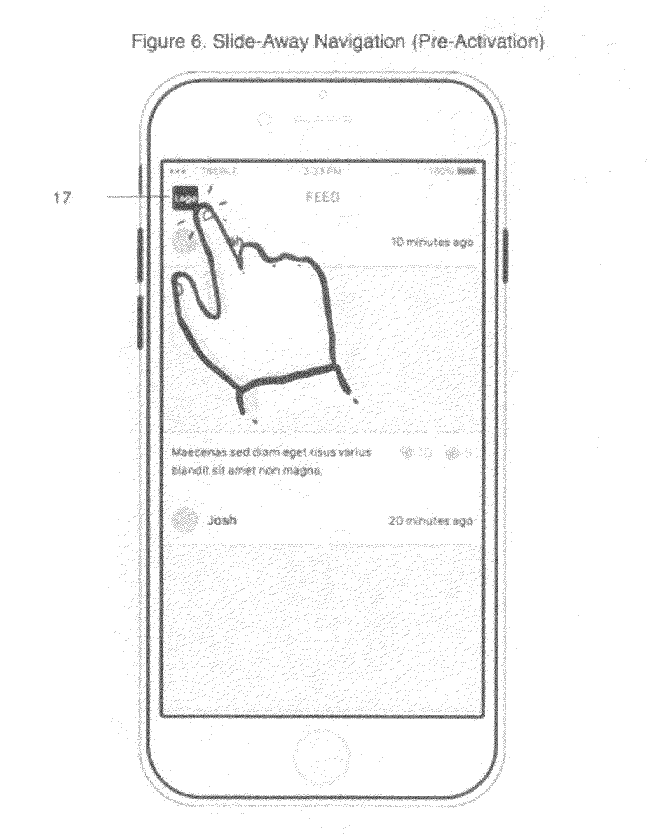

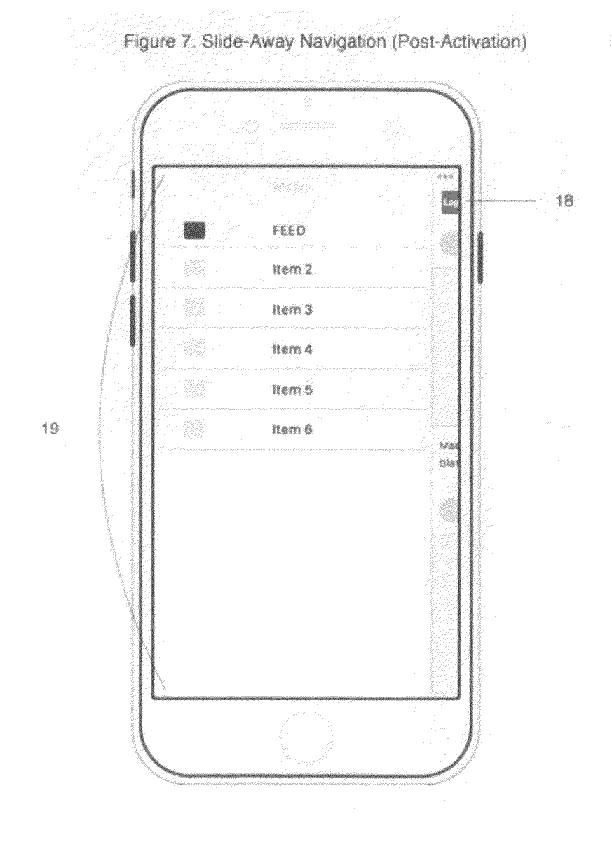

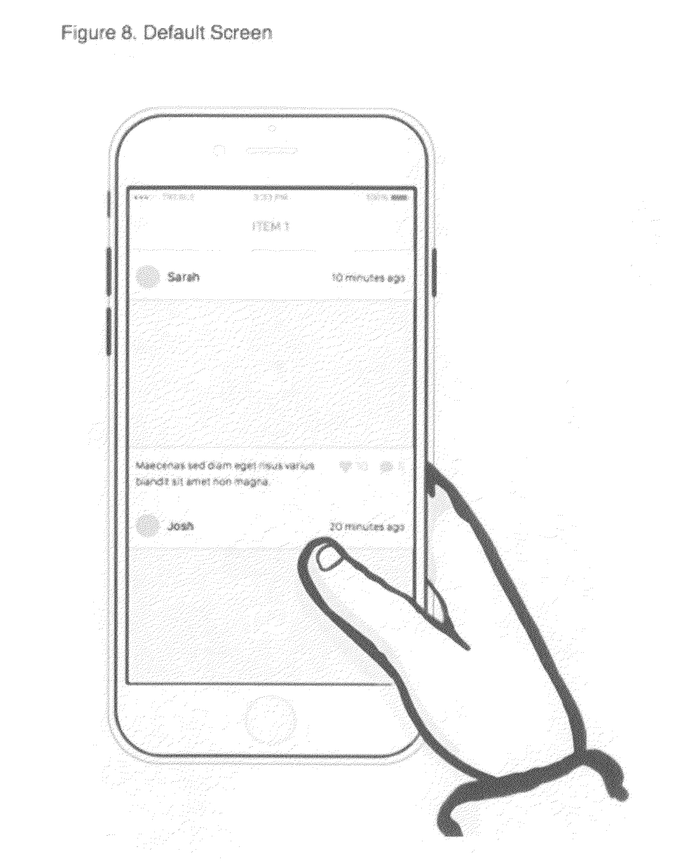

The “Pull and Swipe” concept uses a unique two-step gesture to access a hidden menu and its embedded menu items. With reference to FIG. 8, in a default screen, the menu remains inactive and off screen until the first of the two-step gestures “Pull”is initiated. This solves friction points 1(a), 1(b), 1(c), and 1(d) as described in the background of the invention. The menu bar does not come into play, and is hidden from view, until activated by the user, and thus has no impact to on screen real estate; nor does it affect user gameplay or immersion.

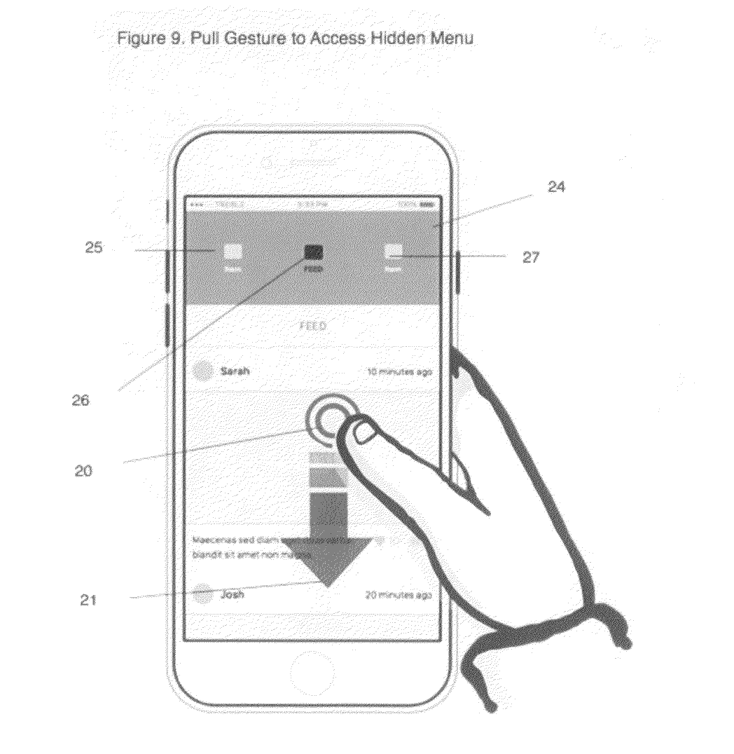

With reference to FIG. 9, once the “Pull” gesture is initiated by using the downward pulling motion from position 20 to 21, a hidden menu 24 reveals to allow users to see a list of menu items 25, 26, 27. For our drawings, we have chosen to anchor the hidden menu 24 at the top of the touch screen. However, for our patent purposes we note that this hidden menu can also be anchored to the bottom of the screen, or to any part of the screen for that matter. We are seeking full patent protection on the concept regardless of where the menu bar is anchored.

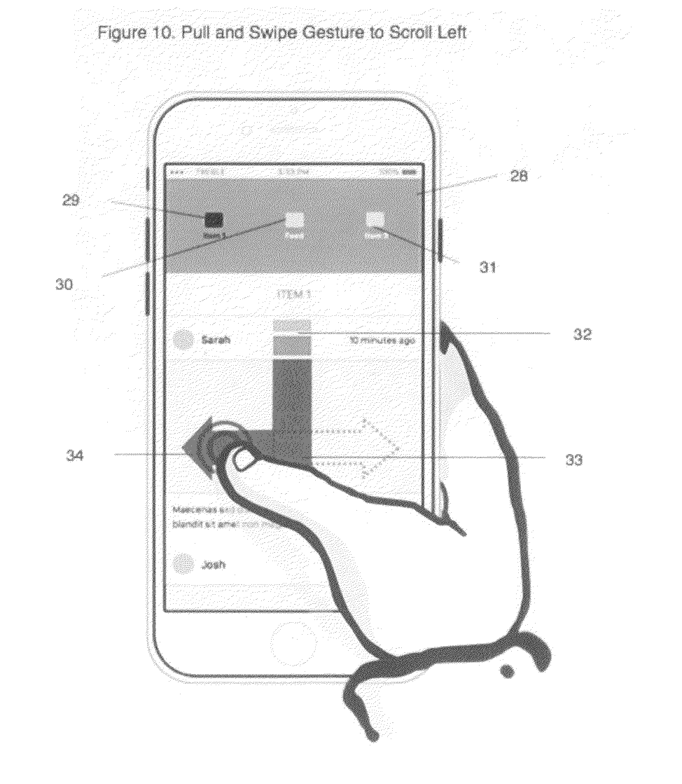

With reference to FIG. 10, once the hidden menu 28 is revealed using the “Pull” gesture from position 32 to 33, users have the option to execute the second step of the contiguous two-step heuristic gesture to “Swipe” through the menu items 29, 30, 31 in either direction. The direction of the swipe (either left or right) corresponds directly to the direction of the scroll through the menu bar 28.

With reference to FIG. 10, in this example, if a user “Pulls” down from position 32 to position 33 and “Swipes” left from position 33 to position 34 in one contiguous motion, this gesture would highlight the menu item 29 and allow the user to preview the contents of menu item 29.

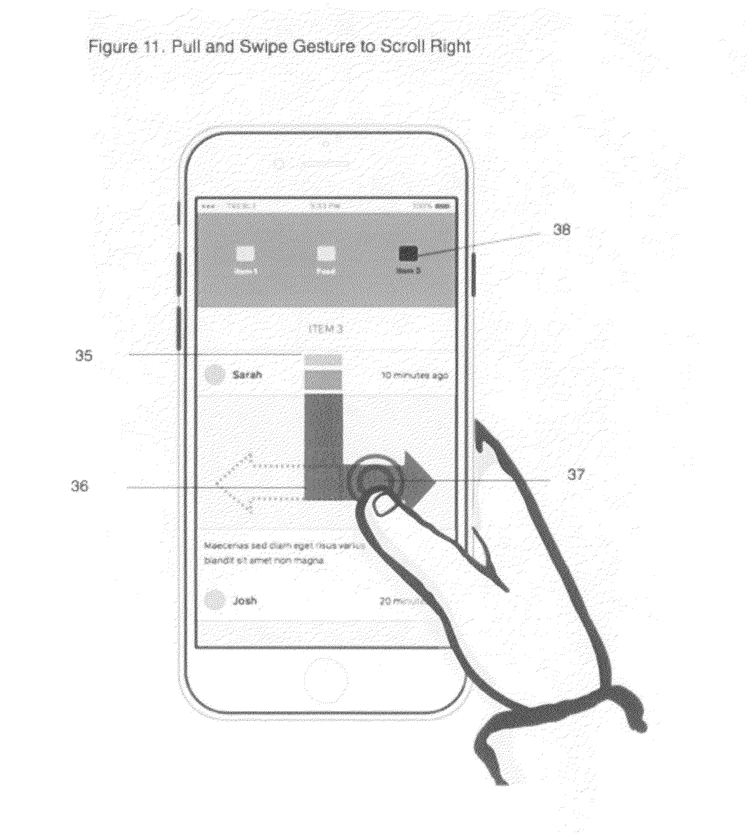

With reference to FIG. 11, in this example, if a user “Pulls” down from position 35 to position 36 and “Swipes” right from position 36 to position 37 in one contiguous motion, this gesture would highlight the menu item 38 and allow the user to preview the contents of menu item 38.

The swipe function is touch sensitive and uses geospatial references to determine the desired scroll destination, meaning the farther you swipe in either direction, the more it will scroll through the menu in that particular direction to access corresponding menu items.

Swiping either left or right serves as a toggle not dissimilar to the ALT+TAB function on a PC, allowing users to toggle between pages and menu items. Highlighting a menu item will bring the user to the corresponding content associated with the selected item (in preview mode), whilst still preserving the status and content of the previous item the user was on. Only when touch contact is released from the device screen following a heuristic gesture or series of heuristic gestures does the highlighted item become active.

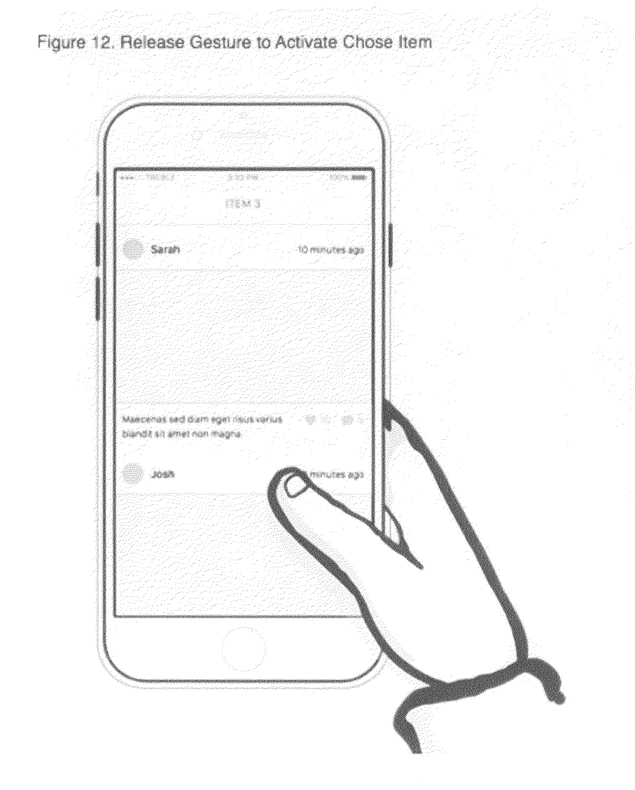

With reference to FIG. 12, by releasing touch contact with the device screen, the user will navigate to the corresponding content associated with the highlighted menu item. The menu bar disappears again into the background and remains hidden from view until the user requires it again.

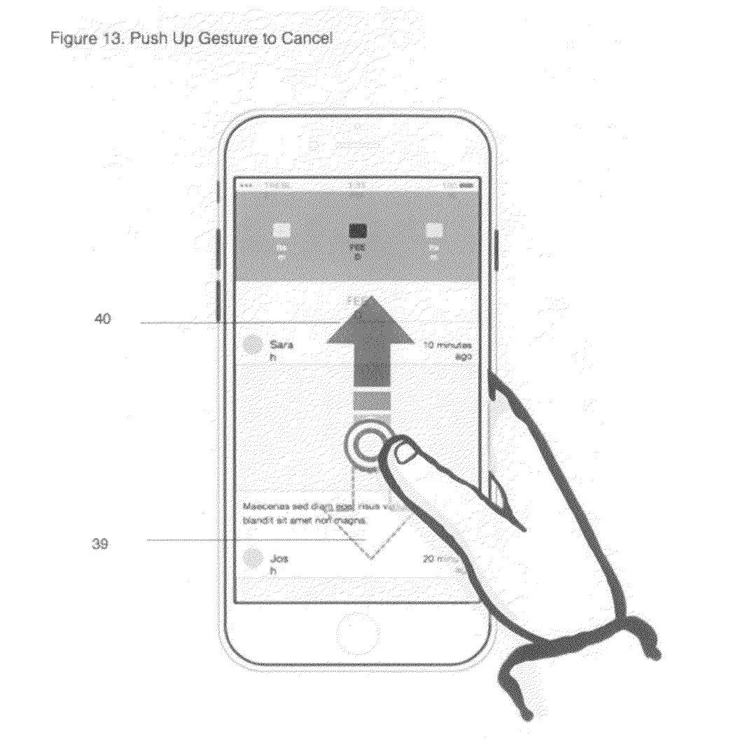

With reference to FIG. 13, users retain the option to cancel a gesture by simply using a “Push” gesture in an upward motion. In this example, the user has initiated a pull gesture from position 40 to position 39 and has revealed hidden menu bar 41.s As long as the continuous touch contact with the device screen has not yet been released, the gesture remains active and in preview mode. By using a push up gesture from position 39 back to position 40, the user would cancel the action. The state of the original screen will not be impacted, and users would revert to the original screen and resume browsing as if no gestures were initiated at all. The push up heuristic can also be applied after a two-part “Pull and Swipe” heuristic is active, and the user would return to the original screen in its original state.

To solve the friction points pertaining to ease of access as highlighted in 1(f) of the background of the description, all of the gesture commands (pull, push, swipe left, swipe right) described are executable from anywhere on the touch-screen. Users will no longer be compelled to reach for unnaturally far corners of the touch-screen in order to access a menu, and can seamlessly navigate using one hand.

What is claimed is:

1. At a computing device with a touch screen display, a User Interface design that hides preselected menu items and icons out of sight until revealed and activated using a computer-implemented method, as outlined below.

2. A computer-implemented method for touch screen displays, comprising:
detecting one or more finger contacts with the touch screen display; applying one or more heuristics to the one or more finger contacts to determine a command for the device; and processing the command; wherein the one or more heuristics comprise:
a. a “pull” heuristic for determining that one or more finger contacts executing a vertical pull gesture in a downward motion anywhere on the touch screen corresponds to the surfacing and subsequent activation of a previously hidden menu(s) and/or hidden icon(s) when the page is anchored to the top of the touch screen
b. a next item “swipe” heuristic for determining that one or more finger contacts executing a horizontal swipe gesture in either a leftward or rightward motion anywhere on the touch screen corresponds to a one-dimensional horizontal screen scrolling command, allowing the user to pan across menus and/or icons revealed using the “pull” heuristic outlined above. Icons are highlighted and/or selected based on the horizontal position of the finger virtually mapped to the top menu
c. a combined “pull and swipe” heuristic for determining that one or more finger contacts executing a singular continuous motion that consists of gestures derived from the two separate heuristics outlined above corresponds to the surfacing and activation of previously hidden menu(s) and/or hidden icon(s) and subsequent panning across menus and/or icons revealed;
d. a “push” heuristic for determining that one or more finger contacts executing a vertical push gesture in an upward motion anywhere on the touch screen corresponds to the cancellation of any aforementioned heuristics in process;
e. a “release” heuristic for determining that the release of one or more finger contacts during the execution of either the “pull,” “swipe,” “pull and swipe,” or “push” heuristics constitutes an acceptance of the selected status of the heuristic in process.

3. The computer-implemented method of claim 2, subsection a., wherein a normal downward scroll motion is able to be delineated from a “pull” heuristic when the page is not anchored to the top of the touch screen; whereby one or more finger contacts executing a vertical pull gesture in a downward motion anywhere on the touch screen corresponds to a normal one-dimensional downward scroll.

4. The computer-implemented method of claim 2, subsection b., wherein the “swipe” heuristic provides for an “over-scroll” capability. By holding (and not releasing) the swipe in either a leftward or rightward direction, the menu items will continue to scroll in the direction held in order to access additional menu items/icons if applicable—this method allows for unlimited scrolling and theoretically infinite menu items and/or icons.

5. The computer-implemented method of claim 2, subsection d., wherein a normal upward scroll motion is able to be delineated from the “push” heuristic when the page is not anchored to the top of the touch screen; whereby one or more finger contacts executing a vertical push gesture in an upward motion anywhere on the touch screen corresponds to a normal one-dimensional upward scroll.
